(19) United States
(12) Patent Application Publication
(10) Pub. No.: US 2007/0084233 A1
(43) Pub. Date: Apr. 19, 2007

(54) Beverage cooler

(76) Inventors: Donald A. Kett, Mississauga (CA); Frank Schraa, Mississauga (CA)

Correspondence Address: BIRCH STEWART KOLASCH & BIRCH, PO BOX 747, FALLS CHURCH, VA, 22040-0747, US

(21) Appl. No.: 11/583,920

(22) Filed: Oct. 20, 2006

Related U.S. Application Data
(63) Continuation-in-part of application No. 10/493,818, filed on Apr. 28, 2004.

(30) Foreign Application Priority Data
Aug. 29, 2002 (CA) 2,400,064

(51) Int. Cl. B67D 5/62; F25D 11/00

(52) U.S. Cl. 62/389; 62/430

(57) ABSTRACT

The beverage cooler includes a vessel for a coolant such as ice water or a conventional coolant such as glycol or Freon. A coil is mounted in the interior of the vessel. The coil is made up of a number of vertically spaced joined circles which are spaced apart from each other and from the interior wall of the vessel. The coil has an inlet through which a beverage from an external source, separate and apart from the cooler, enters the coil. A drain located above the coil carries off excess coolant. A tap at the outlet of the coil controls the flow of the beverage from the coil.

This application is a continuation of application Ser. No. 10/493,818 filed in the United States Patent & Trademark Office on Apr. 28, 2004.

### FIELD OF THE INVENTION

This invention relates to coolers for beverages and more particularly to a cooler which requires no external source of power to operate, is portable and is relatively simple of construction. The invention also relates to a method of operating the cooler. The cooler is particularly suitable for refrigerating beer but is also useful for refrigerating other carbonated beverages such as ginger ale, cola and the like.

### BACKGROUND OF THE INVENTION

Beverage coolers are widely used in such places as bars, restaurants and offices. Such coolers commonly consist of a receptacle for a beverage and refrigerating means which is operated by electricity or natural gas. The coolers are generally quite heavy because of the weight of the refrigerating means and the beverage receptacle and for that reason are not portable. They are also, of course, not suitable for use where there is not a source of power such as on a patio, beside a swimming pool or in the out-of-doors.

The cooler of the subject invention is self-sufficient so that it can be used where there is no source of power. The subject invention also involves a method of operating the cooler. The cooler is portable because it is compact and is relatively light of weight. Lightness is achieved by the elimination of the conventional refrigerating machinery and by the elimination of a receptacle for a beverage.

According to one embodiment of the invention cooling is carried out by ice which is added as needed but is removed when the cooler is being transported. The beverage which the cooler refrigerates remains in its original container and is only within the cooler when it is actually being refrigerated. Only a relatively small quantity of beverage is refrigerated at a time and such quantity adds relatively little to the overall weight of the cooler If, for example, the beverage is beer, the beer remains in its keg until it is ready for consumption. At that time, the keg is connected to the cooler and the beer flows through the cooler to a tap. As the beer flows through the cooler it is refrigerated but should the flow be interrupted, relatively little beer remains in the cooler and such beer adds relatively little to the overall weight of the cooler.

### SUMMARY OF THE INVENTION

Briefly the beverage cooler of the subject invention invention comprises: a vessel for a coolant; a cooling tube disposed within the vessel and through which a beverage to be cooled is adapted to flow, a drain for carrying off excess coolant above the cooling tube; and a tap in liquid-flow commun-ication with the tube from which beverage discharges from the cooler.

The method of use of the cooler includes the steps of: preparing a coolant comprising a number of solids immersed in a liquid cooled to a temperature in the range of about 32 degrees F. to above the freezing point of a beverage to be cooled and introducing the coolant into a vessel in which is located a coil composed of a number of joined vertically spaced circles spaced apart sufficiently from one another that the coolant surrounds each circle. A drain for the liquid is provided. The drain has an inlet located above the coil for withdrawal of any liquid above the coil from the vessel. The beverage is introduced, under pressure, into a lower circle of the coil and the beverage is caused to pass upwardly through the circles of the coil with resulting cooling of the beverage.

### DESCRIPTION OF THE DRAWINGS

The beverage cooler of the subject invention is described with reference to the accompanying drawings in which:

FIG. 1 is an elevation of one embodiment of the cooler, partly in section;

FIG. 2 is a plan view of a second embodiment of the cooler;

FIG. 3 is an elevation of the second embodiment, illustrated schematically; and

FIGS. 4 and 5 illustrate third and fourth embodiments, respectively, of the cooler illustrated schematically.

Like reference characters refer to like parts throughout the description of the drawings.

### DESCRIPTION OF THE PREFERRED EMBODIMENTS

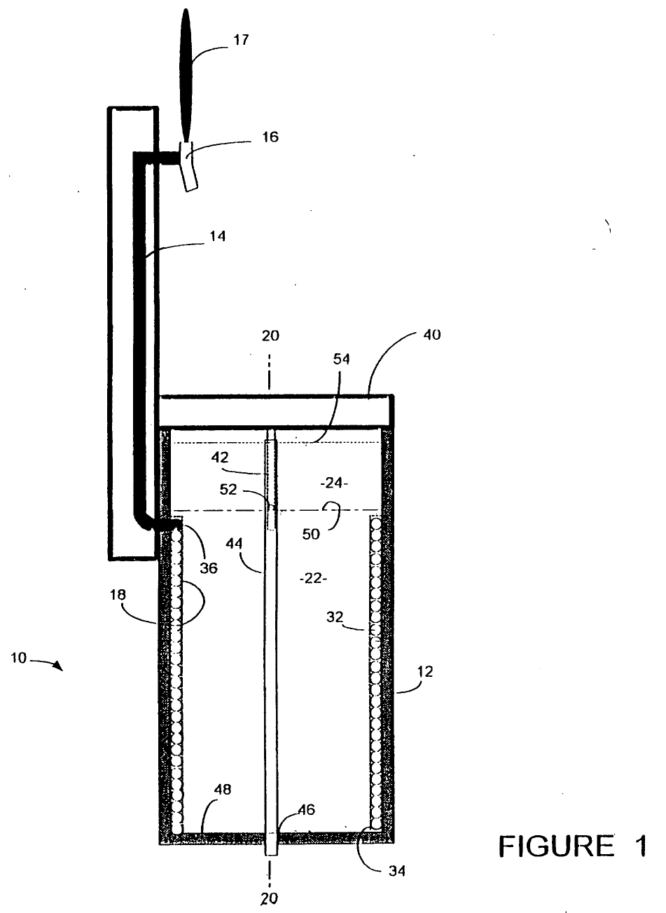

With reference to FIG. 1, the beverage cooler, generally 10, includes a vessel 12 and a hose 14. The hose extends vertically upwardly from the vessel and terminates at a tap 16. Handle 17 opens and closes the tap in the usual manner.

The vessel has a cylindrical inner wall 18 disposed about a vertical longitudinal axis 20-20. The vessel contains a coolant or refrigerant which preferably is ice cubes floating in water.

A cooling tube 32 wound into a coil is mounted within the vessel. The coil is disposed concentrically about axis 20-20. A beverage to be cooled by the ice flows through an inlet (not illustrated) at the lower end 34 of the coil, through the coil where it is cooled by the ice-cooled water and exits from an outlet 36 at the upper end of the coil. The outlet is connected to the lower end of hose 14 while the upper end of the hose is connected to tap 16.

Beverage which discharges from the tap flows downward into a tumbler or other receptacle (not illustrated) on a drip tray 40. The drip tray is seated on top of the vessel and is, in the embodiment illustrated in FIG. 1, removable so that fresh ice and water can be added to the vessel from the top.

Overflow from the beer glass or other receptacle flows onto the drip tray and from there flows into a discharge conduit 42 disposed centrally of the tray. The conduit extends into a drain 44 which is disposed concentrically about axis 20-20. The drain extends downwardly through the vessel and through an opening 46 in the bottom wall 48 of the vessel where the overflow is disposed of.

In operation, the drip tray is removed to gain access to the interior of the vessel. Ice cubes are then added until their level reaches line 54. Excess water over the level of line 50 flows into aperture 52 in drain 44.

A beverage, under pressure, is then introduced into the inlet of the coil. Since the vessel is substantially full of ice, cooling of the beverage will begin as soon as it enters the coil at the bottom of the vessel. The coil is composed of conducting material such as stainless steel, copper or a heat-conducting polymer and the wall of the vessel is insulated to minimize the inward taansfer of heat from outside the vessel. The cooled beverage then flows upwardly through hose 14 and discharges from the tap when it is opened by handle 17. The beverage flows into a tumbler or other like receptacle container which is seated on the drip tray.

Should the tumbler be overfilled, the excess beverage will spill onto the drip tray and exit downwardly through discharge conduit 42 and into drain 44 where it exits from the vessel.

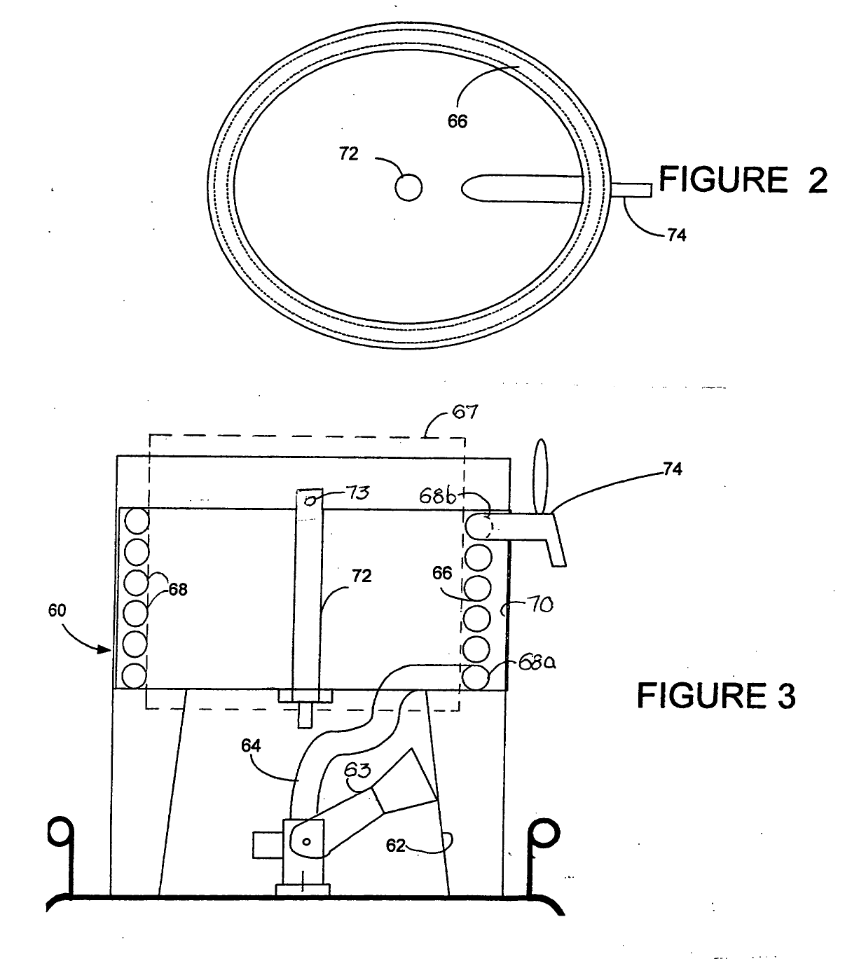

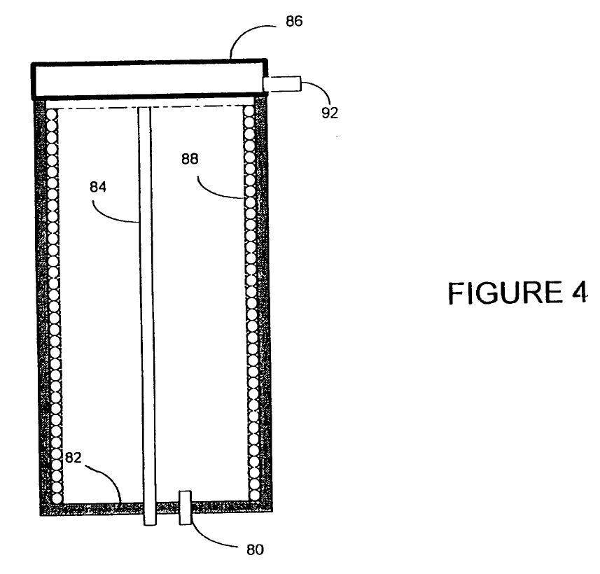

With reference to FIGS. 2 and 3, cooler, generally 60, is mounted on a keg 62 of beer. When handle 63 is opened, beer flows through the tube to coil 66 where it is cooled by ice in the interior of the vessel. The coil winds continuously around an imaginary cylinder 67 and is composed of a number of vertically spaced circles 68 spaced apart sufficiently from one another so that the coolant surrounds each circle. The circles are spaced concentrically inward of the interior wall 70 of the vessel so that the circles are surrounded by the coolant.

A drain 72 serves to remove excess water from the vessel. The drain has an inlet 73 above the coil for withdrawal of any coolant located above the coil

Beer flows under pressure from the keg into a lower circle 68a of the coil, rises within the coil and exits through an outlet in an upper circle 68b located below the inlet 73 of the drain. From the outlet, the beer flows to a tap 74 at the side of the vessel.

The coolant is preferably made up of a saline aqueous liquid such as brine and ice cubes. The ice cubes function to cool the liquid while the salt in the liquid functions to lower its freezing point. By means of the salt, the liquid can be cooled by the ice cubes to a temperature at which the beer is most suitable for consumption without the risk of the liquid freezing. The salt can be table sale or any other well know salts used to adjust the freezing point of a liquid.

In general the temperature of the liquid in the coolant should be within the range of about 32 degrees F. to about 24 degrees F., and preferably in the range of about 30 degrees F. to about 28 degrees F. However the temperature will vary according to the nature of the beer. Lighter beers such as lagers and Pilsners are usually consumed at a different temperature than heavier beers such as ales and stouts. As well, the freezing point of a beer varies according to whether it is light or heavy. The temperature of the liquid in the coolant cannot be below the freezing point of the beer.

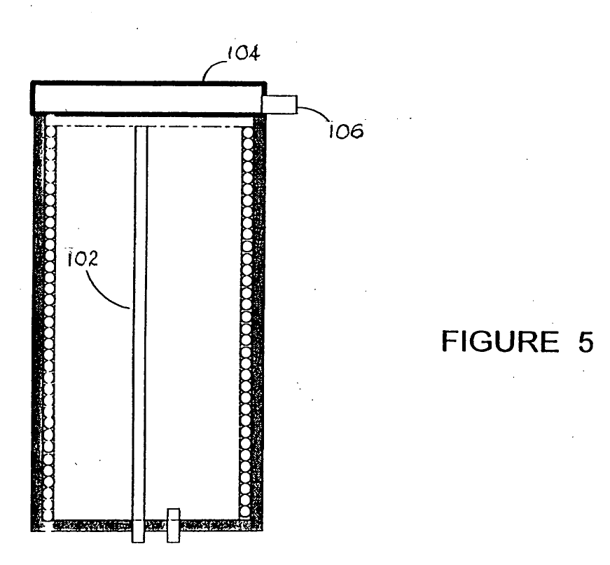

With reference to FIG. 4, cooling of the refrigerant occurs outside the vessel. The coolant can be a conventional coolant such as glycol, Freon or even water and can be gaseous or liquid depending on its temperature of condensation. The coolant is cooled by conventional means which is not part of this invention. The coolant is introduced under pressure through a nozzle 80 at the bottom wall of vessel 82.

The contents of the vessel of FIG. 4 are sealed from the atmosphere. The coolant fills the space within the vessel and a conduit 84 is provided for draining off excess coolant. Since the conduit carries only coolant, the excess can be recycled to the apparatus for further cooling of the coolant.

The top of drip tray 86 is sealed so that no coolant can escape from the top of the vessel. A coil 88 is provided for the beverage. The beverage flows from the coil to a tap (not illustrated). Excess beverage on the drip tray flows to a drain 92 at the side of the tray.

The cooler of FIG. 5 is the same as that illustrated in FIG. 4 except that the contents of the vessel are not sealed from the atmosphere. Excess liquid in the vessel exits through drain 102. The drip tray can be removed to gain access to the contents of the vessel and drip tray 104 can be provided with a discharge conduit at its side such as at 106 to remove excess beverage on the drip tray.

It will be understood of course that modifications can be made in the beverage cooler described and illustrated herein without departing from the scope and purview of the invention as defined in the appended claims.

We claim:

1. A method of cooling a beverage comprising the steps of:
(a) preparing a coolant comprising a liquid and a plurality of solids immersed therein, said liquid being cooled to a temperature in the range of about 32 degrees F. to above the freezing point of said beverage.
(b) introducing said coolant into a vessel in which is located a coil composed of a number of joined vertically spaced circles spaced apart sufficiently from one another so that the coolant surrounds each said circle;
(c) providing a drain having an inlet located above said coil for withdrawal of any said liquid located above said coil from said vessel:
(d) introducing said beverage into a lower circle of said coil;
(e) causing said beverage to pass upwardly through the circles of said coil above said lower circle with resulting cooling of said beverage; and
(f) withdrawing said cooled beverage from said coil from an upper circle of said coil.

2. A method of claim 1 further including the step of withdrawing said cooled beverage from a tap in said coil, said tap being located beneath said drain.

3. The method of claim 1 further including the step of forming the circles of said coil such that the circles wind continuously along an imaginary cylinder.

4. The method of claim 1 including the step of adjusting the temperature of the liquid in said coolant to a temperature in the range of about 30 degrees F. to about 28 degrees F.

5. The method of claim 1 further including the step of selecting, as the liquid of said coolant, a saline solution having a freezing point above the freezing point of said beverage, and selecting ice as the composition of the solids of said coolant.

6. The method of claim 1 further including the step of providing an external container, separate and apart from said cooler for holding said beverage, prior to cooling thereof, and causing said beverage to flow into said coil.

7. The method of claim 1 further including the step of selecting glycol, Freon and a combination of glycol and Freon as said liquid.

8. The method of claim 1 further including the step of providing a drip tray onto which said discharged beverage is adapted to fall and which has a discharge conduit through which beverage discharged onto said drip tray flows.

9. The method of claim 9 further including the step of removably locating said drip tray upon said vessel and constructing said drip tray such that said tray is removable such that access may be had to the interior of said vessel upon removal of said tray.

10. A beverage cooler comprising: a vessel for a coolant; a coil through which a beverage to be cooled flows, said coil being composed of a number of joined vertically spaced circles spaced apart sufficiently from one another so that the coolant surrounds each said circle, said coil having an inlet located in a lower circle and through which beverage to be cooled is introduced and an outlet located in an upper circle from which cooled beverage discharges; and a drain located above said coil for carrying off excess coolant from said vessel.

11. The beverage cooler of claim 10 further including an external container, separate and apart from said cooler from which said beverage flows to said cooling tube.

12. The beverage cooler of claim 10 wherein said coolant consisting of ice and water.

13. The beverage cooler of claim 10 further including a drip tray onto which said discharged beverage is adapted to fall, said drip tray having a discharge conduit through which beverage discharged onto said drip tray is adapted to flow.

14. The beverage cooler of claim 10 wherein said drip tray is removably disposed upon said vessel, access being had to the interior of said vessel upon removal of said drip tray.

15. A beverage cooler comprising a vessel for a coolant; a cooling tube disposed within said vessel and through which a beverage to be cooled is adapted to flow, said tube winding continuously along an imaginary cylinder, a drain for carrying off excess coolant above said cooling tube; and a tap in liquid-flow communication with said tube from which beverage discharges from said cooler, said vessel having a cylindrical inner surface disposed about an upstanding longitudinal axis and being adapted to hold said coolant; said drain being upstanding and being disposed concentrically about said longitudinal axis, said drain further having an opening adapted to be disposed at an upper level of coolant within said vessel; said cooling tube being in the form of a coil disposed concentrically about said longitudinal axis and being spaced apart from said inner surface, said coil further having an inlet and an outlet, said tap being in liquid-flow communication with said outlet, said beverage cooler further including a drip tray onto which said discharged beverage is adapted to fall; and a discharge conduit extending downwardly from said drip tray through which beverage discharged onto said drip tray is adapted to flow, said discharge conduit extending through said opening and into said drain such that beverage discharged onto said drip tray flows into said drain.
